(19) United States
(12) Patent Application Publication
(10) Pub. No.: US 2014/0295047 A1
(43) Pub. Date: Oct. 2, 2014

(54) Method of Stabilization of Pet Food Palatant and Fat Systems

(71) Applicant: Kemin Industries, Inc., Des Moines, IA (US)

(72) Inventor: Cris Zorich, Battle Ground, WA (US)

(73) Assignee: Kemin Industries, Inc., Des Moines, IA (US)

(21) Appl. No.: 14/257,699

(22) Filed: Apr. 21, 2014

Related U.S. Application Data
(62) Division of application No. 13/352,942, filed on Jan. 18, 2012.
(60) Provisional application No. 61/433,619, filed on Jan. 18, 2011.

(51) Int. Cl. C11B 5/00

(52) U.S. Cl. CPC C11B 5/0092
USPC 426/546

(57) ABSTRACT

Adding an antioxidant including an extract of Labiatae species to a fat and palatant coating for pet food significantly reduced the loss of antioxidant and extended the shelf life of the pet food.

This application is a divisional application of U.S. patent application Ser. No. 13/352,942, filed on Jan. 18, 2012, which claims priority to U.S. Patent Application Ser. No. 61/433,619, filed Jan. 18, 2011, which is incorporated herein in its entirety by this reference.

### BACKGROUND OF THE INVENTION

The invention relates generally to stabilization of pet food and, more specifically, to the stabilization of preventing the loss of antioxidant compounds in combined pet food palatant and fat systems.

Pet foods are formulated to provide complete and balanced nutrition to the animal. Due to distribution channels a packaged diet shelf life of up to 18 months is typically required. Degradation of oxygen sensitive nutrients must be controlled with antioxidants. Methods for reducing the prooxidant challenge of pet food ingredients thereby reducing the rate of antioxidant utilization serve to deliver the formulated nutrition over long term diet shelf life.

Fat is an important part of pet food diets. Fat is an energy source for the animal, facilitates the absorption of fat soluble nutrients and contributes to a desirable flavor profile. Unprotected fat, however, is subject to degradation over time turning rancid and developing an off-flavor that results in the pet food being unpalatable to the animal. Antioxidants are added to the fat and often the formulated pet food to extend the shelf life of the pet food and delay oxidative degradation of the fat. Increasingly, palatants are being added to the pet food to improve the palatability of the diet and increase acceptability of the pet food to pet or companion animals. Unfortunately, it has been found that a high degree of antioxidant sacrifice or loss can take place due to the interaction of specific palatants and fat in pet food diet surface coatings.

### SUMMARY OF THE INVENTION

The present invention consists of a method of limiting the loss of antioxidant from a pet food diet coated with fat and/or oil and a palatant comprising adding an antioxidant composition containing non-polar antioxidants in combination with mid-polar antioxidants and/or polar antioxidants. In an alternative embodiment, the antioxidant composition is delivered by including it within the palatant.

The non-polar antioxidants may be present in the fat and/or oil and the mid-polar and/or polar antioxidants may be present in the palatant. The antioxidants are provided at levels adequate to reduce or limit the antioxidant loss due to the interaction between the fat and the palatant. In a preferred embodiment of the present invention, the palatant would have an increased level of antioxidants above that required to stabilize the palatant alone, wherein the excess antioxidants act to stabilize the fat and palatant coating system.

The present invention also includes the addition of a chelator which may or may not be added to the palatant.

The fat and/or oil and the palatant may be mixed together prior to coating the pet food or may be applied separately to the pet food.

### BRIEF DESCRIPTION OF THE FIGURE

FIG. 1 is a chart of showing that the combination of Group 2 mid-polar oil soluble rosemary extract with the Group 1 non-polar tocopherol antioxidant controls the initial interaction of the fat and palatant resulting in higher residual tocopherol (102 ppm, 122 ppm) versus the 1× (68 ppm) or 2× (94 ppm) tocopherol rates alone.

### DETAILED DESCRIPTION OF PREFERRED EMBODIMENTS

Fat utilized for pet foods include edible vegetable oils, edible poultry fat and edible beef tallow which are also suitable for human consumption. Non-edible fats typically utilized in pet foods include fish oils, poultry fat, choice white pork grease and beef tallow. All of these fats, defined as triglycerides, are stabilized with antioxidants in order to prevent rancidity. Synthetic antioxidants typically used to stabilize fats and oils for pet foods may include, but are not limited to BHA, BHT, propyl gallate, TBHQ and ethoxyquin. Natural stabilization is increasingly preferred which may include, but is not limited to, natural mixed tocopherols, rosemary extract, oregano extract and green tea extract. Synthetic and natural antioxidant systems designed for treating fats may also consist of surfactants and chelators. Examples of surfactants include mono- and diglycerides and lecithin while chelators are typically citric acid, orthophosphates and polyphosphate salts. Chelators are generally water soluble thereby greatly limiting the inclusion rate in an oil soluble antioxidant formula.

Fats rendered and extracted from inedible animal by-products require a more robust antioxidant system than edible fats due to the nature of the raw materials as described in U.S. Pat. No. 5,498,434. Pet food palatants are produced from these same inedible animal by-product raw materials and thus present an even greater oxidative challenge. When the prooxidant challenge of the palatant intermixes with the antioxidant treated fat a very significant loss of antioxidant is immediately observed. Table 1 shows the initial percent tocopherol loss when a liquid chicken viscera/chicken liver based palatant is blended with tocopherol treated poultry fat and BHA loss when a dried liver based palatant is blended with BHA treated tallow.

TABLE 1
Antioxidant Loss Due to Initial Palatant & Fat Interaction

| | BHA to Fat | Loss |
|---|---|---|
| Tallow + BHA | 21 ppm | |
| Tallow + BHA + Dried Liver Palatant | 12 ppm | 43% |
| | Toc to Fat | Loss |
| Poultry Fat + Tocopherol | 414 ppm | |
| Poultry Fat + Toc + Liquid Palatant | 177 ppm | 57% |

Applicant has found that the antioxidant loss due to palatant and fat/oil interaction can be controlled with a system of antioxidants and, optionally, chelators. The system is comprised of one of the following:

Non-polar oil soluble antioxidant and mid-polar oil soluble antioxidant

Non-polar oil soluble antioxidant, mid-polar oil soluble antioxidant and water soluble chelator

Non-polar oil soluble antioxidant and polar water soluble antioxidant

Non-polar oil soluble antioxidant, polar water soluble antioxidant and water soluble chelator

Non-polar oil soluble antioxidant with mid-polar oil soluble and polar water soluble antioxidant

Non-polar oil soluble antioxidant with mid-polar oil soluble and polar water soluble antioxidant plus water soluble chelator

A reduction in antioxidant efficacy occurs due to an interaction of a palatant and fat coating that takes place when the two components are mixed prior to application to the pet food surface or when they comingle on the diet surface after being applied separately. Antioxidants that are employed to stabilize fat only or palatants only often do not adequately control oxidation of the palatant and fat coating systems.

The present invention makes use of antioxidants of diverse polarity. In general, the polarity of an antioxidant is dependent on the polarity of the solvent or solvent system that is used in extracting the antioxidant from the source substrate. More polar solvents extract more polar antioxidants and less polar solvents extract less polar antioxidants.

Examples of non-polar oil soluble antioxidants suitable for use in the present invention include but are not limited to mixed tocopherols, tocotrienols, BHA and BHT.

Examples of mid-polar oil soluble antioxidants suitable for use in the present invention include mid-polar extracts of rosemary, extracts of sage, extracts of tea, and extracts of oregano. Examples of commercially available polar antioxidants include but are not limited to: ROSEEN® brand available from Kemin Nutrisurance, Inc., Des Moines, Iowa; VivOX™ brand available from Vitiva d.d., Markovci, Slovenia; and Herbalox® Seasoning Type O brand available from Kalsec, Inc., Kalamazoo, Mich.

Polar water soluble antioxidants suitable for use in the present invention include polar extracts of rosemary, extracts of sage, extracts of tea and extracts of spearmint. Examples of commercially available polar antioxidants include but are not limited to: AquaROX™ brand available from Vitiva d.d., Markovci, Slovenia; Herbalox® Seasoning brand available from Kalsec, Inc., Kalamazoo; and MIOriganox™ brand antioxidant available from Frutarom, Israel.

Water soluble chelators suitable for use in the present invention include citric acid, orthophosphates, and polyphosphates, including STPP, TSPP, SAPP, and SHMP.

A bench model was developed to quickly assess the prooxidant effect of palatants within pet food coating formulations. The palatant, fat and antioxidant are mixed at the proportions which would be applied to the pet food or kibble surface and antioxidant measured at time zero and after a period of 3-4 days storage at ambient temperature. A direct correlation was found between the degree of coating mix non-polar antioxidant sacrifice and that observed on the coated pet food kibble.

### EXAMPLE 1

A typical commercial chicken and grain based pet food diet having the components and formula listed in Table 2 and the ingredients listed below was used in this first example.

TABLE 2
Commercial Pet Food Formula

| | |
|---|---|
| Chicken Fat with Tocopherol | 7% |
| Liquid Chicken Viscera Digest | 2% |
| Liquid Chicken Liver Digest | 1% |
| Uncoated Kibble | 90% |
| Coated Finished Diet | 100% |

Ingredients of the chicken and grain based diet (core only—coating underlined): Chicken, Chicken By-Product Meal, Corn Meal, Ground Whole Grain Sorghum, Brewers Rice, Chicken Fat (preserved with mixed Tocopherols, a source of Vitamin E), Dried Beet Pulp, Ground Whole Grain Barley, Chicken Flavor, Dried Egg Product, Fish Oil (preserved with mixed Tocopherols, a source of Vitamin E), Potassium Chloride, Salt, Sodium Hexametaphosphate, Flax Meal, Fructooligosaccharides, DL-Methionine, Minerals (Ferrous Sulfate, Zinc Oxide, Manganese Sulfate, Copper Sulfate, Manganous Oxide, Potassium Iodide, Cobalt Carbonate), Choline Chloride, Vitamins (Ascorbic Acid, Vitamin A Acetate, Calcium Pantothenate, Biotin, Thiamine Mononitrate (source of vitamin B1), Vitamin B12 Supplement, Niacin, Riboflavin Supplement (source of vitamin B2), Pyridoxine Hydrochloride (source of vitamin B6), Inositol, Vitamin D3 Supplement, Folic Acid), Calcium Carbonate, Vitamin E Supplement, Brewers Dried Yeast, Beta-Carotene, Rosemary Extract.

Blends of palatant, fat, and antioxidants were prepared according to Table 3 and mixed at 7000 rpm for 30 seconds in a high shear blender. Two levels of tocopherol were compared for rate of loss and an intermediate 85 ppm level of rosemary extract compared to a 215 ppm rate. One preparation was also coated sequentially with the fat plus tocopherol applied to the kibble first followed by the liquid palatant plus rosemary extract. Uncoated kibble was hand coated with the liquid blends in a Kitchen Aid mixer at speed 2 for 2 minutes. The liquid blends and coated diets were tested for tocopherol at time zero and 4 days post-treatment and % tocopherol loss determination.

TABLE 3
Tocopherol Loss of Liquid Coating Blend and Coated Pet Food

| Antioxidant Rate to Fat | | Chicken Fat | Liquid F3³ Palatant | 4-Day Tocopherol Loss | |
|---|---|---|---|---|---|
| Group 1 | Group 2 | to Diet | to Diet | Palatant/Fat Blend | Coated Diet |
| 935 ppm | 0 | 7% | 3% | 16.38% | 20.06% |
| Tocopherol¹ | | | | | |
| 1750 ppm | 0 | 7% | 3% | 16.59% | 20.19% |
| Tocopherol | | | | | |
| 1045 ppm | 85 ppm Rosemary | 7% | 3% | 11.74% | 16.87% |
| Tocopherol | Extract² | | | | |
| 1045 ppm | 85 ppm Rosemary | 7% | 3% Sequential⁴ | na | 17.07% |
| Tocopherol | Extract | | | | |
| 625 ppm | 215 ppm Rosemary | 7% | 3% | 3.7% | 0% |
| Tocopherol | Extract | | | | |

¹Natural mixed tocopherols, Kemin Nutrisurance, Inc., Des Moines, IA
²Oil soluble rosemary extract, Kemin Nutrisurance, Inc., Des Moines, IA
³Palasurance ™ F3Dog Liquid, Kemin Nutrisurance, Inc., Des Moines, IA
⁴Sequential application of 7% fat followed by 3% liquid palatant to diet surface

Increasing the non-polar (Group 1) tocopherol level from 935 ppm to 1750 ppm did not reduce the 20% rate of tocopherol loss when fat is mixed with the liquid palatant. The addition of more polar (Group 2) rosemary extract at 85 ppm (7.5%) to 1045 ppm tocopherol (92.5%) had a positive effect by reducing the tocopherol loss to 17%. Whether the liquid palatant was mixed with the fat prior to application or the fat and palatant coated separately did not impact the tocopherol sacrifice. The greatest advantage was observed with 215 ppm rosemary extract (25%) in conjunction with 625 ppm tocopherol (75%) which resulted in 3.7% loss in the liquid fat/palatant blend and no loss on the coated pet food kibble.

### EXAMPLE 2

The commercial uncoated kibble listed in Example 1 was used for this second example. Blends of palatants, fat, antioxidants plus chelators were prepared according to Table 3 and mixed at 7000 rpm for 30 seconds in a high shear blender. Uncoated kibble was hand coated with the liquid blends in a Kitchen Aid mixer at speed 2 for 2 minutes. The liquid blends and coated diets were tested for tocopherol at time zero and 4 days post-treatment and % tocopherol loss determined. The results are presented in Table 4.

TABLE 4
Tocopherol Loss of Liquid Coating Blend and Coated Pet Food

| | | | | | 4-Day Tocopherol | |
|---|---|---|---|---|---|---|
| Antioxidant | | Chicken | Liquid | Group 4 | Loss | |
| Rate to Fat | | Fat | Palatant³ | Chelator | Palatant/ | Coated |
| Group 1 | Group 2 | to Diet | to Diet | to Diet | Fat Blend | Diet |
| 750 ppm | 0 | 7% | 3% | 0 | 56% | 37% |
| Tocopherol¹ | | | | | | |
| 750 ppm | 260 ppm | 7% | 3% | 0 | 13% | 5% |
| Tocopherol | Rosemary | | | | | |
| | Extract² | | | | | |
| 750 ppm | 260 ppm | 7% | 3% | 0.6% | 0% | 7% |
| Tocopherol | Rosemary | | | Phos | | |
| | Extract | | | Acid⁴ | | |
| 750 ppm | 260 ppm | 7% | 3% | 0.6% | 6% | 2% |
| Tocopherol | Rosemary | | | STPP⁵ | | |
| | Extract | | | | | |

¹Natural mixed tocopherols, Kemin Nutrisurance, Inc., Des Moines, IA
²Oil soluble rosemary extract, Kemin Nutrisurance, Inc., Des Moines, IA
³3% Liquid Palatant = 2% BioFlavor ®PL 610 + 1% Optimizer ® C10029, AFB International, St. Charles, MO
⁴Phos Acid = 75% phosphoric acid
⁵STPP = sodium tripolyphosphate

The initial 4-Day loss of tocopherol (Group 1) in the liquid palatant and fat blend was 56% which corresponded to 37% tocopherol loss on the coated diet. Addition of the more polar oil soluble rosemary extract (Group 2) reduced the liquid coating loss to 13% and the coated diet loss to 5%. Group 4 chelator phosphoric acid, an orthophosphate, prevented any loss of tocopherol in the liquid blend but did not have an advantage over the rosemary extract on the coated diet. STPP, a polyphosphate, reduced the tocopherol loss of the diet to 2% in conjunction with the rosemary extract.

### EXAMPLE 3

A commercial lamb and rice dog food having the components and formula listed in Table 5 and having the ingredients listed below was selected due to a history of shelf life instability.

TABLE 5
Commercial Pet Food Formula

| | |
|---|---|
| Chicken Fat with | 3.2% |
| Tocopherol | |
| Liquid Lamb Digest | 1.8% |
| Uncoated Kibble | 95% |
| Coated Finished Diet | 100% |

Ingredients of the lamb and rice dog food diet (core only—coating underlined): Lamb, Lamb Meal, Brown Rice, Milo, Menhaden Fish Meal, Ground Whole Oats, Ground Whole Barley, Dried Peas, Dried Bananas, Natural Lamb Flavor, Chicken Fat (Naturally preserved with Mixed Tocopherols and Citric Acid), Dried Egg Product, Ground Whole Flaxseed, Dried Carrots, Dried Sweet Potatoes, Tomato Pomace, Brewers Dried Yeast, Potassium Chloride, Salt, Freeze Dried Peas, Dried Cranberries, Fructooligosaccharide, Calcium Carbonate, Zinc Sulfate, Vitamin E Supplement, Choline Chloride, Ferrous Sulfate, Niacin, Copper Sulfate, Thiamine Mononitrate, Calcium Pantothenate, Vitamin A Supplement, Manganous Oxide, Pyridoxine Hydrochloride, Sodium Selenite, Riboflavin, Vitamin D3 Supplement, Biotin, Vitamin B12 Supplement, Calcium Iodate, Folic Acid, Rosemary Extract.

Tocopherol (Group 1), rosemary extract (Group 2) and polyphosphate chelators (Group 4) were mixed into the liquid palatant to deliver levels to the diet according to Table 6. Chicken fat was applied to the uncoated kibble followed by the liquid palatant+treatment and mixed at speed 2 in a Kitchen Aid mixer for 2 minutes. The coated diets were tested for tocopherol at time zero and 4 days post-treatment and % tocopherol loss determined.

TABLE 6
Tocopherol Loss of Coated Pet Food

| | | | | | 4-Day Tocopherol | | | |
|---|---|---|---|---|---|---|---|---|
| Antioxidant Rate to | | Chicken | Liquid | Group 4 | Residual | | | Net |
| Diet via Palatant | | Fat to | Palatant³ | Chelator | Diet | | Net | Tocopherol |
| Group 1 | Group 2 | Diet | to Diet | to Diet | Tocopherol | | Tocopherol | Loss |
| 0 | 0 | 3.2% | 1.8% | 0 | 50 | ppm | | |
| 75 ppm | 0 | 3.2% | 1.8% | 0 | 77 | ppm | 27 ppm | 65.00% |
| Tocopherol¹ | | | | | | | | |
| 75 ppm | 25 ppm | 3.2% | 1.8% | 0 | 92 | ppm | 42 ppm | 44.67% |
| Tocopherol | Rosemary | | | | | | | |
| | Extract² | | | | | | | |
| 75 ppm | 25 ppm | 3.2% | 1.8% | 0.6% | 124 | ppm | 74 ppm | 2.67% |
| Tocopherol | Rosemary | | | STPP⁴ | | | | |
| | Extract | | | | | | | |
| 75 ppm | 25 ppm | 3.2% | 1.8% | 0.6% | 102 | ppm | 52 ppm | 31.33% |
| Tocopherol | Rosemary | | | SHMP⁵ | | | | |
| | Extract | | | | | | | |

¹Natural mixed tocopherols, Kemin Nutrisurance, Inc., Des Moines, IA
²Oil soluble rosemary extract, Kemin Nutrisurance, Inc., Des Moines, IA
³LD460 Liquid Dog
⁴STPP = sodium tripolyphosphate
⁵SHMP = sodium hexametaphosphate

The control diet with no added treatment from the liquid palatant was found to have 50 ppm residual tocopherol. By deducting this basal level from that recovered with added treatment a net 65% loss of the 75 ppm additional tocopherol was determined. Adding higher rates of tocopherol only is not a viable means to increase shelf life due to the sacrifice from palatant and fat interaction. When 25 ppm rosemary extract was included with the tocopherol the loss was reduced to 44.67%. Inclusion of STPP (Group 4) at a rate of 0.6% to the diet via the liquid palatant in conjunction with rosemary extract reduced the tocopherol loss to 2.67%. SHMP added at the 0.6% rate resulted in a 31.33% loss and was not as effective as the STPP.

### EXAMPLE 4

Low fat diets are problematic due to a limited surface fat coating level and resulting non-uniformity of application. Palatants are applied at rates of several percent providing a palatable uniform coating on the pet food kibble surface. Delivering a complete antioxidant system via the palatant is a desirable and unique method of controlling the interaction of surface fat and palatant in order to extend pet food diet shelf life. A canine weight control diet was formulated with the following ingredients: Corn, Oat Flour, Chicken Meal, Oat Hulls, Beet Pulp, Yeast Culture, Chicken Fat (Preserved with Mixed Tocopherols, Rosemary Extract, Citric Acid and Lecithin), Herring Meal, Dried Whole Egg, Liver Digest, Flax Meal, Fish Oil, Minerals (Dicalcium Phosphate, Potassium Chloride, Calcium Carbonate, Potassium Citrate, Sodium Chloride, Zinc Oxide, Zinc Bioplex, Ferrous Sulfate, Iron Bioplex, Manganous Oxide, Copper Sulfate, Copper Bioplex, Calcium Iodate and Organic Selenium), DL-Methionine, Vitamins (Choline Chloride, Vitamin E, Inositol, Niacin, Ascorbic Acid, D-Calcium Pantothenate, Thiamine Mononitrate, Riboflavin, Beta-Carotene, Pyridoxine Hydrochloride, Vitamin A, Folic Acid, Menadione Sodium Bisulfite Complex, Biotin, Vitamin B₁₂ and Vitamin D₃), Fructo-Oligosaccharides, Taurine, High Chromium Yeast, Glucosamine Hydrochloride, L-Carnitine and L-Glutamine.

The canine weight control diet has a total fat content of 7.8% and was coated with 3.1% poultry fat followed by 6.2% palatant whereby the non-polar tocopherol (Group 1) and mid-polar oil soluble rosemary extract (Group 2) were dispersed in the palatant. The antioxidant system (77.5 ppm tocopherol+26 ppm or 52 ppm rosemary extract) was compared to an equivalent level of tocopherol (77.5 ppm) and to a 2× level (155 ppm) of tocopherol for relative diet stability.

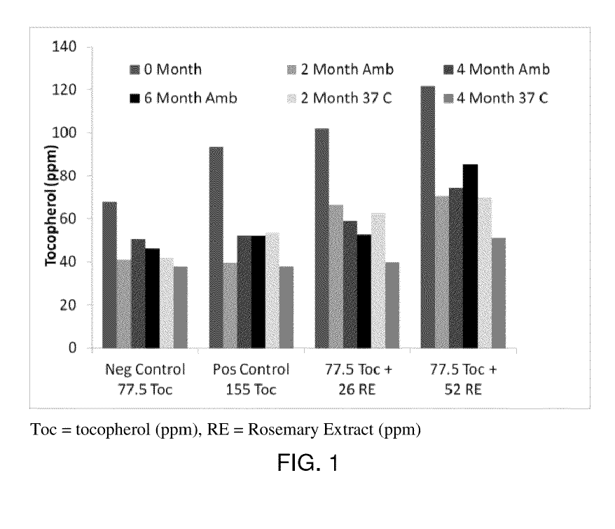

FIG. 1 shows that the combination of Group 2 mid-polar oil soluble rosemary extract with the Group 1 non-polar tocopherol antioxidant controls the initial interaction of the fat and palatant resulting in higher residual tocopherol (102 ppm, 122 ppm) versus the 1× (68 ppm) or 2× (94 ppm) tocopherol rates alone. Greater tocopherol retention continued to be observed for the antioxidant system+palatant compared to tocopherol+palatant over extended ambient and accelerated storage.

### EXAMPLE 5

Lamb and rice diets present a stability challenge whereby the lamb palatant causes a significant antioxidant loss when it interacts with the surface fat upon concurrent coating of the pet food kibble. A lamb meal and rice dog formula was produced having the ingredients: Lamb meal, cracked pearled barley, oatmeal, ground rice, chicken fat (preserved with mixed tocopherols), lamb digest, tomato pomace, sodium tripolyphosphate, flax seed, potassium chloride, taurine, minerals (zinc proteinate, ferrous sulfate, zinc oxide, iron proteinate, copper sulfate, copper proteinate, manganese proteinate, manganous oxide, calcium iodate, sodium selenite), vitamins (vitamin E supplement, L-ascorbyl-2-polyphosphate (source of vitamin C), inositol, niacin supplement, vitamin A supplement, d-calcium pantothenate, thiamine mononitrate, beta-carotene, riboflavin supplement, pyridoxine hydrochloride, menadione sodium bisulfite complex, vitamin D3 supplement, folic acid, biotin, vitamin B12 supplement), choline chloride, yucca schidigera extract, rosemary extract.

Diets were prepared both without and with 0.6% STPP (sodium tripolyphosphate) within the kibble core. Poultry fat was treated with tocopherol (Group 1) and the commercial lamb palatant was utilized as received without additional treatment or inclusive of oil soluble rosemary extract (Group 2) and STPP (Group 4) per Table 7. The fat and palatant were sprayed onto the kibble surface as separate streams via an APEC Mistcoater liquid applicator.

TABLE 7
Lamb Meal & Rice Adult Dog Treatment Matrix

| | Rate to Core | Rate to Diet via Fat | Rate to Diet via Palatant | |
|---|---|---|---|---|
| Treatment | STPP | Toc | RE | STPP |
| Control | 0 | 50 ppm | 0 | 0 |
| Palatant | 0 | 50 ppm | 25 ppm | 0.6% |
| (RE + STPP) | | | | |
| Core STPP + | 0.6% | 50 ppm | 25 ppm | 0 |
| Palatant RE | | | | |
| Core STPP | 0.6% | 50 ppm | 0 | 0 |

Toc = tocopherol,
RE = Rosemary Extract,
STPP = sodium tripolyphosphate

After six months of ambient and accelerated storage the Lamb Meal & Rice diet with a rosemary extract plus STPP system delivered via the palatant was superior in residual tocopherol and hours of Oxygen Bomb stability compared to the control and the cores inclusive of STPP (Table 8).

TABLE 8
Lamb Meal & Rice Long Term Storage Tocopherol and Stability

| | Tocopherol (ppm) | | Oxygen Bomb Stability (hr) | |
|---|---|---|---|---|
| Treatment | 6 Month Ambient | 6 Month 37° C. | 6 Month Ambient | 6 Month 37° C. |
| Control | 20 | 12 | 13 | 16 |
| Palatant | 36 | 21 | >20 | >20 |
| (RE + STPP) | | | | |
| Core STPP + | 17 | 10 | 16 | 12 |
| Palatant RE | | | | |
| Core STPP | 9 | 7 | 10 | 8 |

Kemin Industries, Inc. (1991) “The oxygen bomb test”, Kemin Industries, Inc. publication no. 09001.

### EXAMPLE 6

A 50:50 by weight blend of poultry fat and chicken viscera digest treated with 750 ppm natural mixed tocopherols to the fat exhibited a 16% tocopherol loss 72 hours post-mixing. Addition of more polar water soluble green tea at a 3:1 and 1.5:1 Toc:WSGT ratio reduced the initial loss to 6% thereby reducing the net loss by 60%. Mid-polar oil soluble green tea extract added at the 1:5:1 ratio lowered the net tocopherol loss by 71% whereby the 3:1 Toc:OSGT ratio reduced the net loss by 95%. Rosemary extract included in the fat/digest blend at the 3:1 Toc:RE ratio effectively controlled the tocopherol loss as demonstrated in previous examples. Rosemary extract was also effective in reducing the net loss of synthetic non-polar BHT by 50%. More polar botanical extracts reduce the natural or synthetic non-polar antioxidant net loss by 50%-100% when included in a poultry fat/chicken digest pet food coating blend typical of the industry.

TABLE 9
Poultry Fat and Chicken Viscera Digest Blend 50:50
Ratio 72 Hour Non-Polar Antioxidant Rate of Loss

| | | | | | | | | | Net |
|---|---|---|---|---|---|---|---|---|---|
| | | | | | | | Non-Polar | | Reduction |
| | Ratio | Antioxidant Rate to Fat | | | | | 72 hr. | 72 hr. | in Non- |
| | Non- | Non-Polar | | Mid-Polar/Polar | | | Toc | BHT | Polar |
| | Polar: | Toc | BHT | RE | WSGT | OSGT | loss | loss | Loss |
| Description | Polar | (ppm) | (ppm) | (ppm) | (ppm) | (ppm) | % | % | % |
| Toc | | 750 | | | | | 16% | | |
| Toc + RE | 3:1 | 750 | | | 250 | | −2% | | 113% |
| Toc + | 3:1 | 750 | | | 250 | | 6% | | 62% |
| WSGT | | | | | | | | | |
| Toc + | 1.5:1 | 750 | | | 500 | | 6% | | 60% |
| WSGT | | | | | | | | | |
| Toc + | 3:1 | 750 | | | | 250 | 1% | | 95% |
| OSGT | | | | | | | | | |
| Toc + | 1.5:1 | 750 | | | | 500 | 5% | | 71% |
| OSGT | | | | | | | | | |
| BHT | | | 100 | | | | | 36% | |
| BHT + RE | 2:1 | | 100 | 50 | | | | 18% | 50% |
| BHT + RE | 1:1 | | 100 | 100 | | | | 18% | 50% |

Toc = Natural mixed tocopherols, RE = Rosemary Extract, WSGT = Water Soluble Green Tea Extract, OSGT = Oil Soluble Green Tea Extract, BHT = Butylated hydroxytoluene

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art who have the disclosure before them will be able to make modifications and variations therein without departing from the scope of the invention.

1-6. (canceled)

7. A composition for limiting the tocopherol loss in a pet food liquid surface coating for pet food kibble due to the accelerated oxidizing, prooxidant effect of an inedible animal liquid digest in the coating, comprising a tocopherol and non-tocopherol antioxidant with the tocopherol predominant and comprising two components:
(a) a fat/oil selected from the list consisting of poultry fat, mammal fat, vegetable oil and fish oil combined with tocopherols at 750 ppm to 2500 ppm to the fat/oil; and
(b) a liquid, water-based inedible digest of an animal selected from the list consisting of poultry, beef, pork, lamb and fish digest treated combined with an antioxidant selected from the list consisting of oil-soluble, mid-polar antioxidants and water-soluble, polar antioxidant botanical solvent extracts at 250 ppm to 1500 ppm to the digest.

8. A composition of claim 7, wherein the tocopherol rates to the fat/oil and total botanical extracts to the liquid digest to preferably yield a ratio of 1.5:1 to 3:1 tocopherol:botanical extract in the coating.

9. A composition of claim 7, wherein the fat/oil is poultry fat and the botanical extract is rosemary extract and wherein the fat:digest ratio is 1:1 and the tocopherol:rosemary extract ratio is 3:1.

10. A composition of claim 7, wherein the fat/oil and digest coating has a ratio of tocopherol:rosemary extract of 3:1 and wherein said coating reduces the net tocopherol loss by 60% or greater compared to a coating of fat/oil with the same level of tocopherol plus the digest without the rosemary extract.

11. A composition of claim 10, wherein the net tocopherol loss is reduced by 60% or greater when the coating is applied to the surface of pet food kibble.

12. A composition of claim 11, further comprising 0.6% STPP (sodium tripolyphosphate) whereby the net tocopherol loss by is reduced by not less than 80%.

13. A composition of claim 7, wherein the level of botanical extract is in excess of that required to stabilize the coating alone.

14. A composition of claim 7, further comprising sodium trypolyphosphate (STPP), wherein tocopherol is added to poultry fat, the botanical extract and STPP are added to the digest, wherein the ratio of tocopherol to botanical extract is 2:1, and wherein the treated poultry fat and treated digest are applied separately to the pet food kibble surface resulting in an increase in residual tocopherol level by 80% after 6 months of ambient storage compared to pet food kibble coated without the botanical extract.

15. A composition of claim 7, wherein the non-polar antioxidant is synthetic and wherein use of a synthetic antioxidant:botanical extract ratio of 1:1 to 2:1 reduces net synthetic antioxidant loss by at least 50% compared to use of the synthetic antioxidant without the botanical extract.

16. A composition of claim 7, further comprising adding a orthophosphate or polyphospate to the liquid digest at a level to deliver 0.6% phosphate to the pet food kibble and results in a reduction of the the net tocopherol loss in the liquid coating by at least 80%.

17. A composition of claim 16, wherein the polyphosphate is sodium tripolyphosphate (STPP).

18. A composition of claim 7, wherein the botanical extract is selected from the list consisting of extracts of rosemary, green tea and spearmint used singly or in combination.

19. A pet food coating composition, comprising 50% poultry fat and 50% chicken viscera based liquid digest, wherein the poultry fat is treated with 750 ppm tocopherol and the digest is treated with between 250 ppm to 500 ppm of a botanical extract selected from the list consisting of mid-polar, oil-soluble rosemary extract, polar, water-soluble green tea extract and mid-polar, oil-soluble green tea extract to yield a tocopherol:botanical extract ratio of 1.5:1 to 3:1.

20. A pet food kibble coating, comprising:
(a) an oil soluble non-polar tocopherol treated fat/oil; and
(b) an oil soluble mid-polar or water soluble polar botanical extract treated liquid inedible animal digest whereby the fat and liquid digest are either mixed together prior to application to the pet food kibble surface or applied separately to the pet food kibble surface.
